(19) United States
(12) Patent Application Publication
(10) Pub. No.: US 2011/0148945 A1
(43) Pub. Date: Jun. 23, 2011

(54) D/A CONVERTER CIRCUIT AND ITS VOLTAGE SUPPLY CONTROL METHOD

(75) Inventor: Satoru MATSUDA, Kanagawa (JP)

(73) Assignee: Renesas Electronics Corporation

(21) Appl. No.: 12/967,499

(22) Filed: Dec. 14, 2010

(30) Foreign Application Priority Data
Dec. 22, 2009 (JP) 2009-290360

(51) Int. Cl. G09G 3/36; G09G 5/10

(52) U.S. Cl. 345/690; 345/89

(57) ABSTRACT

A DAC includes a DAC unit that selects one of a plurality of selection voltages according to an input digital signal, and outputs the selected selection voltage as an analog signal, a first power-supply voltage terminal through which a first power-supply voltage is supplied to a first terminal of a transistor constituting the DAC unit upon power-up of the DAC unit, and a voltage supply control unit that detects a potential difference between the first power-supply voltage and a second voltage used to generate the selection voltages, outputs a voltage corresponding to the first power-supply voltage to a second terminal of the transistor constituting the DAC unit when the potential difference is larger than a predetermined value, and outputs a voltage corresponding to the second voltage to the second terminal of the transistor constituting the DAC unit when the potential difference is smaller than the predetermined value.

### INCORPORATION BY REFERENCE

This application is based upon and claims the benefit of priority from Japanese patent application No. 2009-290360, filed on Dec. 22, 2009, the disclosure of which is incorporated herein in its entirety by reference.

### BACKGROUND

1. Field of the Invention

The present invention relates to a D/A converter circuit and its voltage supply control method.

2. Description of Related Art

In recent years, the development of large flat display devices has become increasingly active. Among these large flat displays, LCDs (Liquid-crystal Displays) are getting attention because of their lower power consumption and other merits. LCDs are equipped with an LCD driver IC (Integrated Circuit) that drives pixels arranged in matrix on the display.

FIG. 12 shows a configuration of an LCD driver IC1 in related art. As shown in FIG. 12, the LCD driver IC1 includes a logic circuit 10, a level-shifter 20, a D/A converter (DAC) circuit 30, and an output-stage buffer 40.

The logic circuit 10 generates digital gray-scale signals each of which is composed of n bits (hereinafter, an assumption is made that n=6) and which are used to determine the gray-scale signal of each pixel. Note that the digital gray-scale signal has a CMOS signal level, e.g., a voltage around 4V.

The level-shifter 20 shifts the level of a digital gray-scale signal generated by the logic circuit 10 to a high potential around 10V.

The DAC circuit 30 converts a digital gray-scale signal output from the level-shifter 20 into an analog gray-scale signal. The DAC circuit 30 selects one of supplied selection voltages VP1 to VP64 and one of selection voltages VN1 to VN64 and outputs the selected voltages to the output-stage buffer 40 in order to generate the analog gray-scale signal.

The output-stage buffer 40 performs current-buffering for the analog gray-scale signal supplied from the DAC circuit 30, and outputs the buffered current to display pixels.

FIG. 13 shows the configuration of the DAC circuit 30. As shown in FIG. 13, the DAC circuit 30 includes a PchDAC 31, an NchDAC 32, and a ladder resistor unit 33. Note that in LSDs, it is necessary to reverse the polarity of voltage applied between a pixel electrode and its opposed electrode at certain intervals in order to prevent the degradation of the liquid-crystal material. Polarity switches SW51 and SW52, which are provided to perform this polarity reverse of voltage applied to the pixel electrode, are connected on the input side and the output side, respectively, of the DAC circuit 30.

The ladder resistor unit 33 receives voltages VP1, VP64, VN1 and VN64 from external terminals TVP1, TVP64, TVN1 and TVN64 respectively, and generates selection voltages VP1 to VP64 and selection voltages VN1 to VN64 (which are described later). Note that there are relations “VP1>VP64” and “VN1<VN64”.

The PchDAC 31 receives a digital gray-scale signal from the level-shifter 20, selects one of the selection voltages VP1 to VP64 according to the digital gray-scale signal, and outputs the selected selection voltage as an output selection voltage VPout. The NchDAC 32 receives a digital gray-scale signal from the level-shifter 20, selects one of the selection voltages VN1 to VN64 according to the digital gray-scale signal, and outputs the selected selection voltage as an output selection voltage VNout.

FIG. 14 shows a graph showing a relation between input digital gray-scale signals and output analog gray-scale signals of the DAC circuit 30. Note that FIG. 14 shows a relation in an example where the panel is normally-while and the input digital signal has six bits. As shown in FIG. 14, when a digital gray-scale signal D[5:0] is [000000] in the positive-polarity output state, for example, the PchDAC 31 selects and outputs the selection voltage VP1. Further, when the digital gray-scale signal D[5:0] is [000001], the PchDAC 31 selects and outputs the selection voltage VP2. The PchDAC 31 operates in a similar fashion for the subsequent digital gray-scale signals. Finally, when the digital gray-scale signal D[5:0] is [111111], the PchDAC 31 selects and outputs the selection voltage VP64. In the negative-polarity output state, similar digital-analog conversions are performed with the NchDAC 32.

FIG. 15 shows a detailed configuration of the PchDAC 31 and the ladder resistor unit 33. Note that as for the ladder resistor unit 33, only the part of configuration corresponding to the PchDAC 31 is illustrated.

As shown in FIG. 15, the ladder resistor unit 33 includes resistive elements R1 to R63. The ladder resistor unit 33 generates intermediate voltages VP2 to VP63 between the voltages VP1 and VP64, which are applied from the external terminals TVP1 and TVP64 respectively, at respective nodes each between one of the resistive elements R1 to R63 and its neighboring resistive element. Further, the ladder resistor unit 33 outputs these voltages as selection voltage VP1 to VP64 to the PchDAC 31.

The PchDAC 31 includes switch circuits SW1_1 to SW1_32 SW2_1 to SW2_16, SW3_1 to SW3_8, SW4_1 to SW4_4, SW5_1, SW5_2, and SW6_1. For example, the switch circuit SW1_1 receives the selection voltages VP1 and VP2 and outputs one of the received selection voltages VP1 and VP2 according to the value of the LSB (Least Significant Bit), i.e., D[0] of a 6-bit digital gray-scale signal. Similarly, each of the switch circuits SW1_2 to SW1_32 receives its corresponding two selection voltages among the selection voltages VP3 to VP64, and outputs one of the received selection voltages according to the value of the digital gray-scale signal D[0].

Next, for example, the switch circuit SW2_1 receives the output voltages of the switch circuits SW1_1 and SW1_2 and outputs one of the received voltages according to the value of the digital gray-scale signal D[1]. Similarly, each of the switch circuits SW2_2 to SW2_16 receives its corresponding two output voltages among the output voltages of the switch circuits SW1_3 to SW1_32, and outputs one of the received voltages according to the value of the digital gray-scale signal D[1].

Next, for example, the switch circuit SW3_1 receives the output voltages of the switch circuits SW2_1 and SW2_2 and outputs one of the received voltages according to the value of the digital gray-scale signal D[2]. Similarly, each of the switch circuits SW3_2 to SW3_8 receives its corresponding two output voltages among the output voltages of the switch circuits SW2_3 to SW2_16, and outputs one of the received voltages according to the value of the digital gray-scale signal D[2].

Next, for example, the switch circuit SW4_1 receives the output voltages of the switch circuits SW3_1 and SW3_2 and outputs one of the received voltages according to the value of the digital gray-scale signal D[3]. Similarly, each of the switch circuits SW4_2 to SW4_4 receives its corresponding two output voltages among the output voltages of the switch circuits SW3_3 to SW3_8, and outputs one of the received voltages according to the value of the digital gray-scale signal D[3].

Next, for example, the switch circuit SW5_1 receives the output voltages of the switch circuits SW4_1 and SW4_2 and outputs one of the received voltages according to the value of the digital gray-scale signal D[4]. Similarly, the switch circuit SW5_2 receives the output voltages of the switch circuits SW4_3 and SW3_4, and outputs one of the received voltages according to the value of the digital gray-scale signal D[4].

Finally, the switch circuit SW6_1 receives the output voltages of the switch circuits SW5_1 and SW5_2 and outputs one of the received voltages as an output selection voltage VPout according to the value of the MSB (Most Significant Bit), i.e., D[5] of the 6-bit digital gray-scale signal.

FIG. 16 shows the configuration of the switch circuit SW1_1. Each of the other switch circuits SW1_2 to SW1_32, SW2_1 to SW2_16, SW3_1 to SW3_8, SW4_1 to SW4_4. SW5_1, SW5_2 and SW6_1 has a similar configuration to that of the switch circuit SW1_1, and therefore their explanations are omitted. As shown in FIG. 16, the switch circuit SW1_1 includes PMOS transistors MPH and MPL, and an inverter circuit IVL. Note that, for the sake of convenience, the example shown in FIG. 16 is drawn as if every switch circuit includes an inverter. However, in practice, it is common to generate a signal D[5:0] and its inverted signal outside the DAC and supply the generated signals to respective switches. Such configurations may be also employed.

The selection voltage VP1 is input to either one of the source and the drain of the PMOS transistor MPH, and the other one of the source and the drain is connected to a node A. Further, the digital gray-scale signal D[0] is input to the gate of the PMOS transistor MPH.

The selection voltage VP2 is input to either one of the source and the drain of the PMOS transistor MPL, and the other one of the source and the drain is connected to the node A. Further, the inverted signal/D[0] of the digital gray-scale signal D[0], which is obtained through the inverter IVL, is input to the gate of the PMOS transistor MPL.

The back-gates of the PMOS transistors MPH and MPL are both connected to a power-supply voltage terminal VDD2.

Note that the NchDAC 32 has a fundamentally similar configuration to that of the PchDAC 31 except for the voltage of the back-gate. Further, the part of the ladder resistor unit 33 corresponding to the NchDAC 32 also has a fundamentally similar configuration to that of the PchDAC 31.

FIG. 17 shows a schematic diagram showing a sequence of the LCD driver IC1 performed upon power-up. Note that the voltage supplied to the LCD driver IC1 shown in FIG. 12 includes a power-supply voltage VDD1 around 4V that is used by the logic circuit 10 capable of operating at a low voltage, and a power-supply voltage VDD2 for high-voltage driver power supply of 10V or higher that is actually used to drive the pixels of the liquid-crystal panel. Further, it also includes the above-described external voltages that are used to supply desired voltages to the DAC circuit 30. In the example shown in FIG. 13, the voltages VP1, VP64, VN1 and VN64 correspond to the external voltages.

As shown in FIG. 17, firstly, the power-supply voltage VDD1 around 4V for use in the logic circuit 10 rises at a time t1. Then, at a time t2, the logic circuit 10 starts to operate and thereby outputs an output signal SGNL. Further, at a time t3, the power-supply voltage VDD2 for high-voltage driver power supply rises. Then, the voltages VP1, VP64, VN1 and VN64, which are voltages supplied from the external terminals, rise at a time t4.

As described above, in the DAC circuit 30 of the LCD driver IC1 (in particular, R-DAC scheme), externally-supplied power-supply voltages VDD1 and VDD2, voltages obtained by dividing externally-supplied external voltages inside the IC, or voltages obtained by a similar manner are exerted on each component of the DAC circuit 30.

Note that in the case of source drivers IC for dot inversion drive, there are positive-polarity output and negative-polarity output. When the above-described LCD driver IC1 is used as a source driver for dot inversion drive, each of the positive-polarity side DAC circuit (PchDAC 31 of FIG. 13) and the negative-polarity side DAC circuit (NchDAC 32 of FIG. 13) only needs to have a withstand voltage equivalent to the half of the power-supply voltage VDD2 as explained above with reference to FIG. 14. That is, the withstand voltage between the back-gate and the source, between the back-gate and the drain, and between the back-gate and the gate of the PMOS transistor constituting each switch circuit of the PchDAC 31 only needs to be about the half of the power-supply voltage VDD2. Such a low-withstand-voltage transistor requires a small transistor area. Therefore, it is possible to achieve chip-shrinking corresponding to the withstand voltage equivalent to the half of the power-supply voltage VDD2 in the DAC circuit 30.

Note that Japanese Unexamined Patent Application Publication No. 8-179270 (Patent document 1) discloses a technique to prevent malfunctions from occurring upon power-up in source drivers and the like. Further, Japanese Unexamined Patent Application Publication No. 8-264792 (Patent document 2) discloses a technique to prevent destruction of components that would otherwise occur at the time of power-on of the power supply for liquid-crystal drive when the power-on is performed in an incorrect sequence.

### SUMMARY

The present inventors have found the following problem. As described above, the chip-shrinking corresponding to the withstand voltage equivalent to the half of the power-supply voltage VDD2 is possible in the LCD driver IC1 for dot inversion drive. However, as shown in FIG. 17, for example, since the voltages VP1 and VP64 supplied from the external terminals have not risen sufficiently at a time t5, the potential difference VR from the power-supply voltage VDD2 could exceed the half of the power-supply voltage VDD2. In such a situation, the potential difference exceeds the withstand voltage between the back-gate and the source, between the back-gate and the drain, and between the back-gate and the gate of the PMOS transistor constituting each switch circuit of the positive-polarity side DAC circuit (PchDAC 31 of FIG. 13). As described above, there is a possibility that a voltage higher than the withstand voltage is transiently exerted on the components of the positive-polarity side DAC circuit (PchDAC 31 of FIG. 13) upon power-up. Therefore, the margin of the component-withstand-voltage cannot be reduced, thus imposing a restriction on the chip-shrinking.

Further, as a countermeasure to avoid such a state that a voltage higher than the withstand voltage is transiently exerted on the component of the positive-polarity side DAC circuit as described above, it is necessary to add an additional control circuit that controls the power-up sequence in the power supply that generates the voltages VP1 and VP64 supplied through the external terminals. However, this countermeasure requires adding the additional control circuit in the power supply that supplies the voltages through the external terminals, thus causing demerits such as increase in the design costs and increase in the circuit size. As a result, the merit obtained by carrying out the chip-shrinking could be cancelled out.

Further, Patent document 1 also discloses a method for bringing input signals to the gray-scale voltage circuit itself into a high-impedance state for a certain period after the power-on. However, in this circuit disclosed in Patent document 1, it is necessary to add transistors constituting switches used to bring the input signals into a high-impedance state as well as its control circuit having a withstand voltage equivalent to VDD2. Therefore, the layout size of the chip cannot be reduced.

Meanwhile, Patent document 2 discloses a semiconductor device (driver) including therein switch elements that operate so that power-supply voltages are supplied into the semiconductor device in order in accordance with a certain sequence, and a circuit that controls that sequence operation. However, this circuit also requires using transistors capable of withstanding VDD2 not only for the additional transistors constituting switches and the like that produce the power-supply sequence inside the circuit, but also for other components in the circuit. Therefore, the layout size of the chip cannot be reduced.

A first exemplary aspect of the present invention is a D/A converter circuit for a drive circuit provided in a display device, including: a D/A converter unit that selects one of a plurality of selection voltages according to an input digital gray-scale signal, and outputs the selected selection voltage as an analog gray-scale signal; a first power-supply voltage terminal through which a first power-supply voltage is supplied to a first terminal of a transistor constituting the D/A converter unit upon power-up of the D/A converter unit; and a voltage supply control unit that detects a potential difference between the first power-supply voltage and a second voltage used to generate the selection voltages, outputs a voltage corresponding to the first power-supply voltage to a second terminal of the transistor constituting the D/A converter unit when the potential difference is larger than a predetermined value, and outputs a voltage corresponding to the second voltage to the second terminal of the transistor constituting the D/A converter unit when the potential difference is smaller than the predetermined value.

In the D/A converter circuit in accordance with an exemplary aspect of the present invention, the voltage between the first and second terminals of the transistor constituting the D/A converter unit never increases to or above the predetermined value. Therefore, it is possible to set the withstand voltage between the first and second terminals of the transistor constituting the D/A converter unit to a value equal to or smaller than the predetermined value.

The D/A converter in accordance with an exemplary aspect of the present invention can control the withstand voltage of transistor components constituting the circuit to a value equal to or smaller than the predetermined value, thus making it possible to reduce the component size and thereby to achieve the chip-shrinking.

### BRIEF DESCRIPTION OF THE DRAWING

The above and other exemplary aspects, advantages and features will be more apparent from the following description of certain exemplary embodiments taken in conjunction with the accompanying drawings, in which:

FIG. 1 is an example of a configuration of a DAC circuit in accordance with a first exemplary embodiment of the present invention;

FIG. 2 is an example of a voltage supply control circuit in accordance with a first exemplary embodiment of the present invention;

FIG. 3 is a timing chart for explaining an operation of a voltage supply control circuit in accordance with a first exemplary embodiment of the present invention;

FIG. 4 shows a detailed configuration of a PchDAC and a ladder resistor unit in accordance with a first exemplary embodiment of the present invention;

FIG. 5 is a schematic diagram showing a sequence of an LCD driver IC in accordance with a first exemplary embodiment of the present invention performed upon power-up;

FIG. 6 is another example of a voltage supply control circuit in accordance with a first exemplary embodiment of the present invention;

FIG. 7 is an example of a voltage supply control circuit in accordance with a second exemplary embodiment of the present invention;

FIG. 8 is a timing chart for explaining an operation of a voltage supply control circuit in accordance with a second exemplary embodiment of the present invention;

FIG. 9 is a schematic diagram showing a sequence of an LCD driver IC in accordance with a second exemplary embodiment of the present invention performed upon power-up;

FIG. 10 is another example of a voltage supply control circuit in accordance with a second exemplary embodiment of the present invention;

FIG. 11 shows a detailed configuration of a PchDAC and a ladder resistor unit in accordance with another exemplary embodiment of the present invention;

FIG. 12 is a block diagram of a typical LCD driver IC;

FIG. 13 is an example of a configuration of a DAC circuit in related art;

FIG. 14 is a graph showing a relation between an input digital gray-scale signal and an output analog gray-scale signal of a typical DAC circuit;

FIG. 15 shows a configuration of a typical PchDAC;

FIG. 16 shows a configuration of a switch circuit provided in a typical PchDAC; and

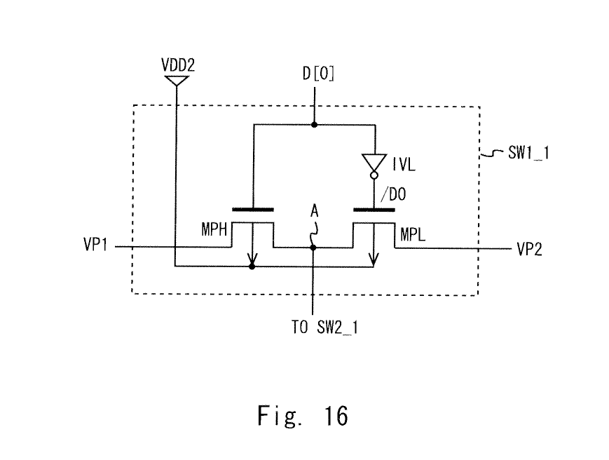

FIG. 17 is a schematic diagram showing a sequence of an LCD driver IC in related art performed upon power-up.

### DETAILED DESCRIPTION OF THE EXEMPLARY EMBODIMENTS

### First Exemplary Embodiment

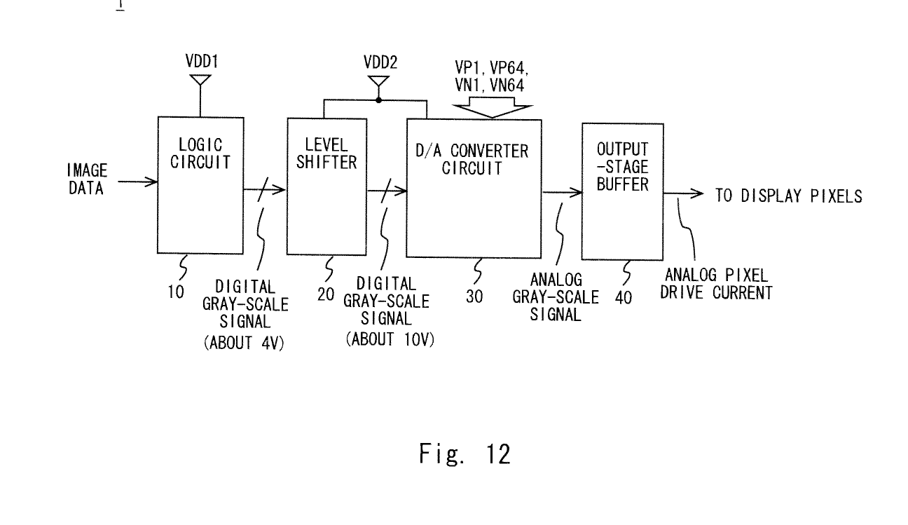

A first specific exemplary embodiment to which the present invention is applied is explained hereinafter in detail with reference to the drawings. In this first exemplary embodiment, the present invention is applied to a DAC circuit 100 of an LCD driver 1C of a liquid-crystal display device. Note that the configuration of the LCD driver IC including the DAC circuit in accordance with this first exemplary embodiment is similar to that of the LCD driver IC1 shown in FIG. 12 except that the DAC circuit 30 is replaced by the DAC circuit 100, and therefore its explanation is omitted.

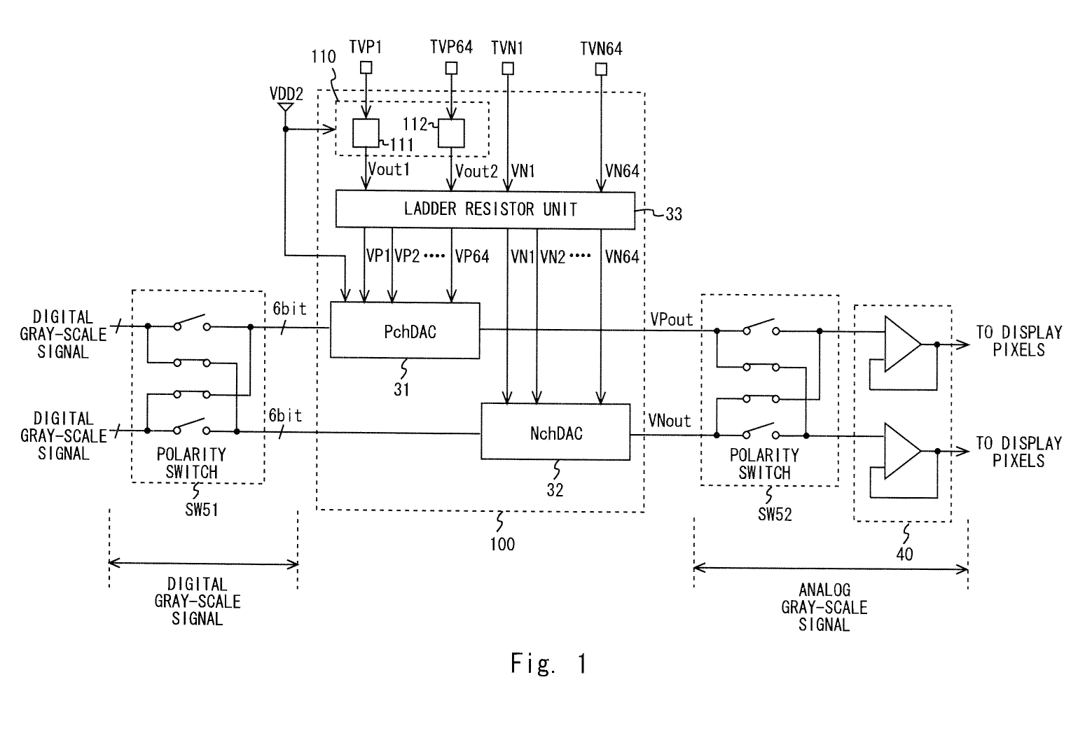

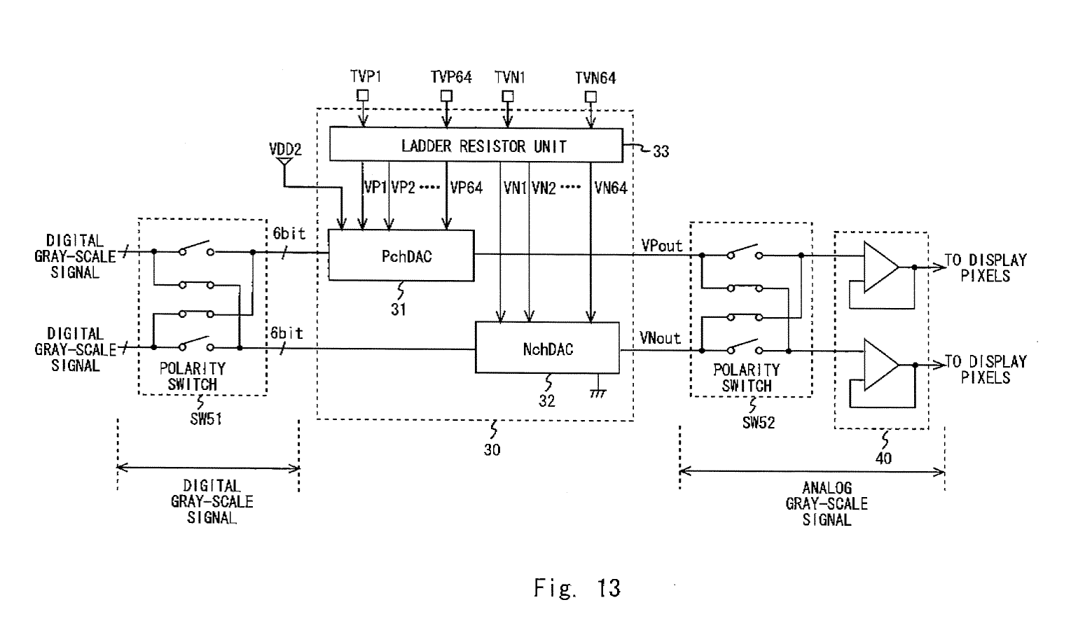

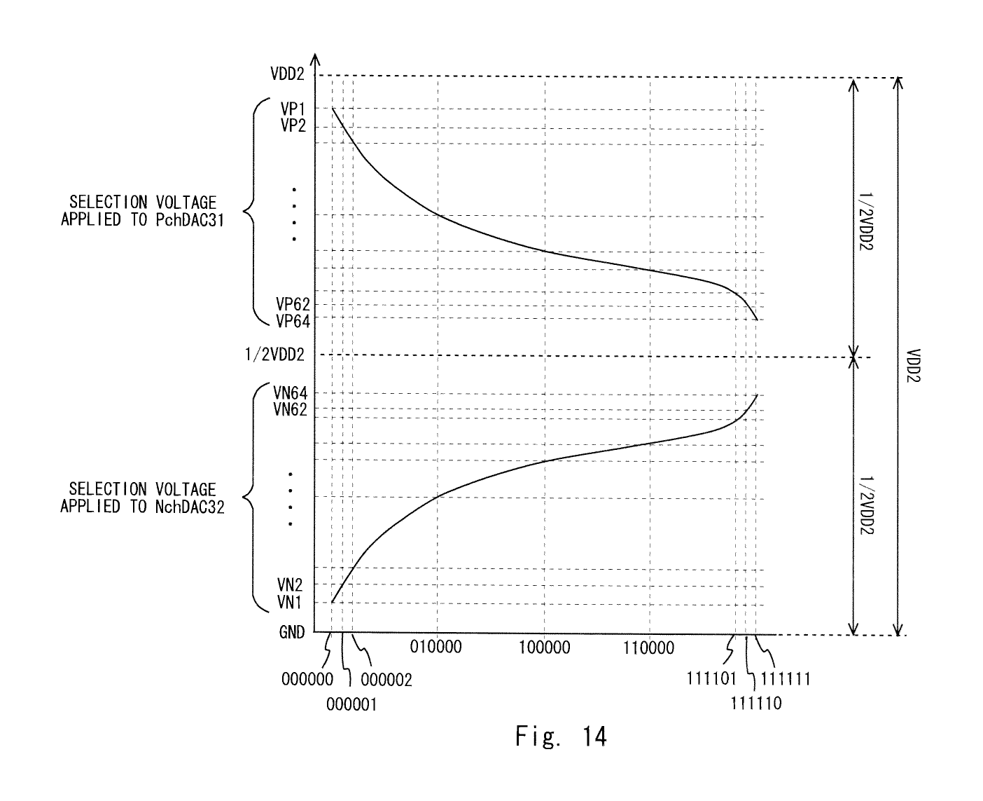

FIG. 1 shows a configuration of the DAC circuit 100 in accordance with this first exemplary embodiment. Similarly to the DAC circuit 30 shown in FIG. 13, polarity switches SW51 and SW52 are connected to the input side and output side, respectively, of the DAC circuit 100 in this first exemplary embodiment. As shown in FIG. 1, the DAC circuit 100 includes a PchDAC 31, an NchDAC 32, a ladder resistor unit 33, and a voltage supply control unit 110. Assume that the selection voltages selected for a digital gray-scale signal by the PchDAC 31 and the NchDAC 32 have a similar relation to the graph shown in FIG. 14.

The voltage supply control unit 110 includes voltage supply control circuits 111 and 112. The voltage supply control circuit 111 receives a voltage supplied from an external terminal TVP1 and a power-supply voltage VDD2 supplied from a power-supply voltage terminal VDD2. Then, it outputs an output voltage Vout1 (which is explained later) to the ladder resistor unit 33. The voltage supply control circuit 112 receives a voltage supplied from an external terminal TVP64 and the power-supply voltage VDD2 supplied from the power-supply voltage terminal VDD2. Then, it outputs an output voltage Vout2 (which is explained later) to the ladder resistor unit 33.

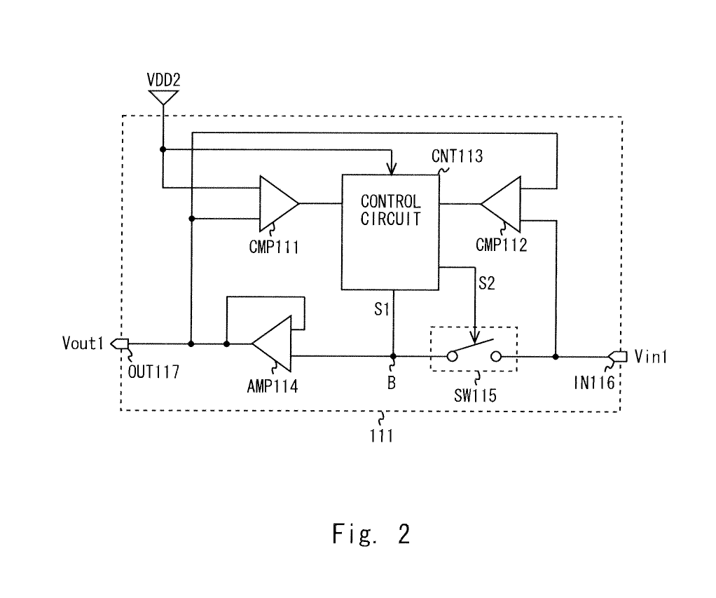

FIG. 2 shows a configuration of the voltage supply control circuit 111. As shown in FIG. 2, the voltage supply control circuit 111 includes comparison detectors CMP111 and CMP112, a control circuit CNT113, an output amplifier AMP114, a switch circuit SW115, an input terminal IN116, and an output terminal OUT117.

The input terminal IN116 receives a voltage supplied from the external terminal TVP1. Note that the potential appearing at this input terminal IN116 is represented as “input voltage Vin1”.

The output amplifier AMP114 outputs a voltage corresponding to a potential level at a node B to the output terminal OUT117. The output amplifier AMP114 is formed as a voltage follower circuit. Note that the potential appearing at this output terminal OUT117 is represented as “output voltage Vout1”.

The comparison detector CMP111 monitors the power-supply voltage VDD2 and the output voltage Vout1, and detects a potential difference between them. Then, it outputs a detection result to the control circuit CNT 113.

The comparison detector CMP112 monitors the input voltage Vin1 and the output voltage Vout1, and detects a potential difference between them. Then, it outputs a detection result to the control circuit CNT 113.

The switch circuit SW115 is connected between the node B and the input terminal IN116. Then, the On/Off state of the switch circuit SW115 is controlled according to a switch control signal S2 output by the control circuit CNT113. For example, when a switch control signal S2 at a high level is input to the switch circuit SW115 it becomes an On-state and electrically connects the node B to the input terminal IN116. Further, when a switch control signal S2 at a low level is input to the switch circuit SW115, it becomes an Off-state and electrically cuts off the node B from the input terminal IN116.

The control circuit CNT113 outputs a voltage control signal S1 to the node B according to the detection results of the comparison detectors CMP111 and CMP112, and also outputs a switch control signal S2 to the switch circuit SW115. More specifically, the control circuit CNT113 outputs a voltage control signal S1 having a potential level substantially equal to the power-supply voltage VDD2 to the node B according to the detection result of the comparison detector CMP111 so that the potential difference between the power-supply voltage VDD2 and the output voltage Vout1 is kept from becoming wider. Further, based on the detection result of the comparison detector CMP112, when the potential difference between the input voltage Vin1, i.e., voltage supplied from the external terminal TVP1 and the output voltage Vout1 becomes a predetermined value (e.g., about 0.2V), the control circuit CNT113 performs control to raise the switch control signal S2 to a high level. Note that an assumption is made here that the output of the voltage control signal S1 is stopped at the moment when the switch control signal S2 rises to a high level.

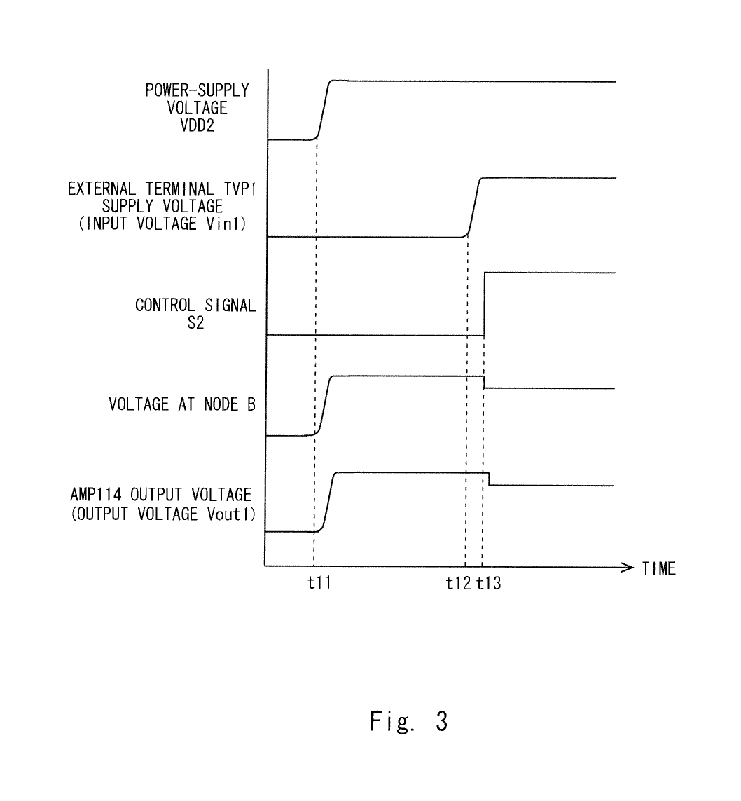

FIG. 3 shows a timing chart for explaining an operation of the voltage supply control circuit 111. As shown in FIG. 3, firstly, the power-supply voltage VDD2 is turned on at a time t11 and the potential of the power-supply voltage VDD2 gradually rises. At this point, the control circuit CNT113 raises the potential level of the voltage control signal S1 according to the detection result of the comparison detector CMP111 so that the potential difference between the power-supply voltage VDD2 and the output voltage Vout1 is kept from becoming wider. As a result, the output amplifier AMP114 outputs a voltage substantially equal to the power-supply voltage VDD2 as the output voltage Vout1.

Meanwhile, the comparison detector CMP112 detects that no voltage is supplied from the external terminal TVP1 or that the potential of the supplied voltage is low. The control circuit CNT 113 maintains the switch control signal S2 at a low level based on this detection result, and the switch circuit SW115 electrically cuts off the node B from the input terminal IN116.

Next, at a time t12, the voltage supplied from the external terminal TVP1 is turned on and the potential of the input voltage Vin1 gradually rises. Further, at a time t13, the comparison detector CMP112 detects that the potential difference between the input voltage Vin1 and the output voltage Vout1 becomes a predetermined value. The control circuit CNT113 raises the switch control signal S2 to a high level based on this detection result, and the switch circuit SW115 electrically connects the node 13 to the input terminal IN116. As a result, the potential of the input voltage Vin1, i.e., the voltage supplied from the external terminal TVP1 is input to the output amplifier AMP114. Therefore, the output amplifier AMP114 outputs a voltage substantially equal to the voltage supplied from the external terminal TVP1 as the output voltage Vout1.

Note that the configuration of the voltage supply control circuit 112 is similar to that of the voltage supply control circuit 111. However, a voltage supplied from the external terminal TVP64 is input to the input terminal IN116 of the voltage supply control circuit 112. In the following explanation, the voltage supplied from the external terminal TVP64 is referred to as “input voltage Vin2” (Vin2<Vin1) as necessary. Further, an assumption is made that an output voltage Vout2 (Vout2≦Vout1) is output to the output terminal OUT117 of the voltage supply control circuit 112.

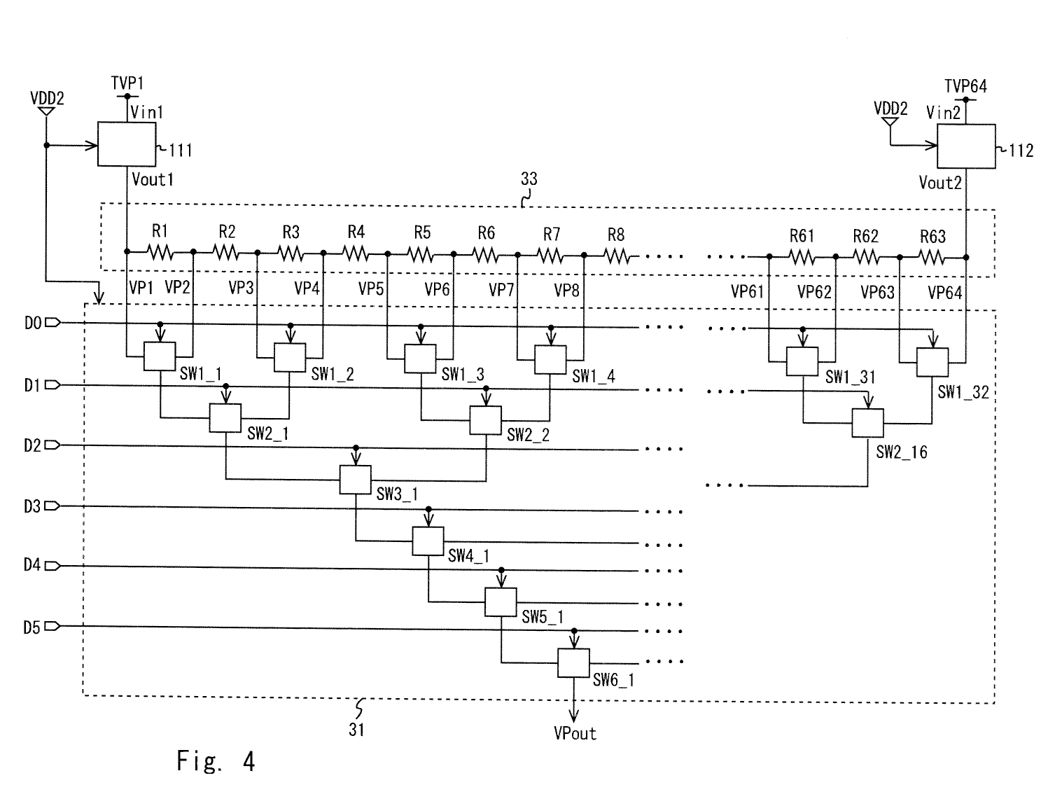

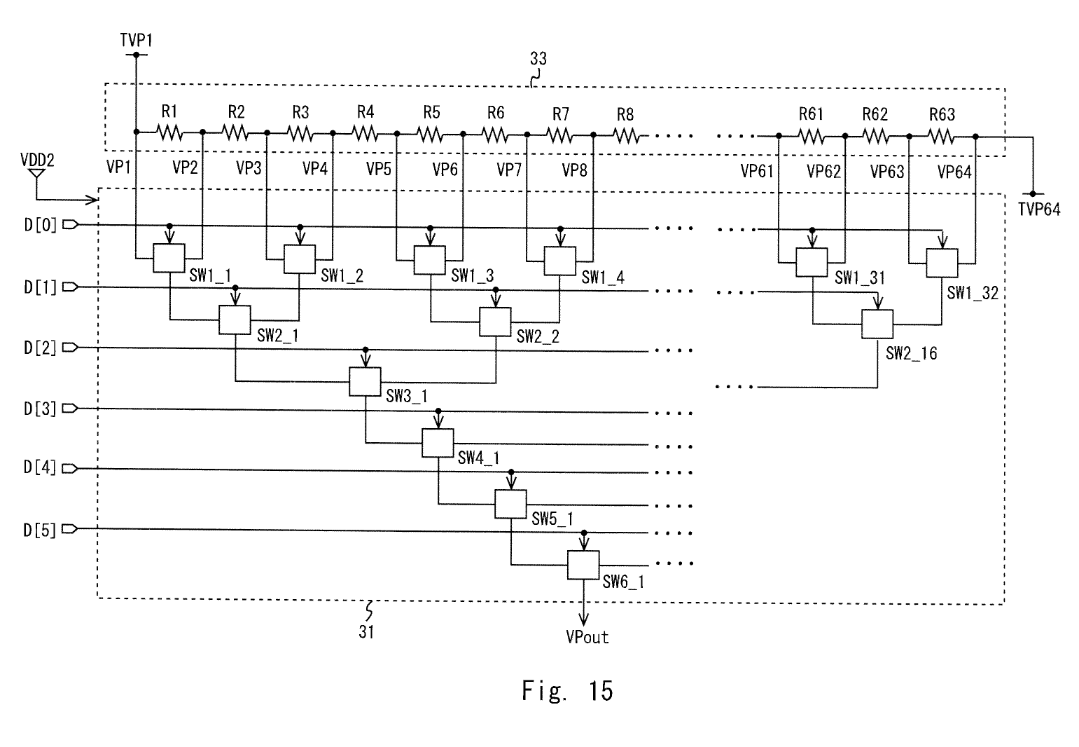

FIG. 4 shows a detailed configuration of a PchDAC 31 and a ladder resistor unit 33. Note that the configurations of the PchDAC 31 and the ladder resistor unit 33 are similar to those described above with reference to FIG. 15, and therefore their explanations are omitted here. The configuration shown in FIG. 4 is different from that shown in FIG. 15 in that the external terminals TVP1 and TVP64 connected to the ladder resistor unit 33 in FIG. 15 are replaced by the voltage supply control circuits 111 and 112 in FIG. 4. Because of this modification, the selection voltages VP2 to VP63 output from the ladder resistor unit 33 to the PchDAC 31 are generated as intermediate potentials between the output voltages Vout1 and Vout2.

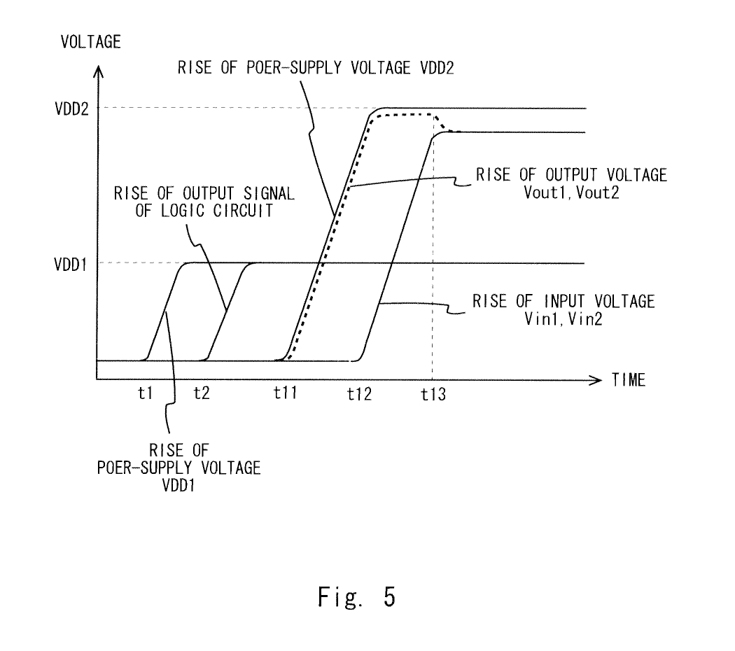

FIG. 5 is a schematic diagram showing a sequence of an LCD driver IC in accordance with this first exemplary embodiment performed upon power-up. As shown in FIG. 5, firstly, the power-supply voltage VDD1 around 4V that is used by the logic circuit 10 rises at a time t1. Then, at a time t2, the logic circuit 10 starts to operate and thereby outputs an output signal SGNL. Next, at a time t11, the power-supply voltage VDD2 for high-voltage driver power supply rises. At this point, as explained above with reference to FIG. 4, the output voltage Vout1. Vout2 from the voltage supply control circuit 111, 112 rises so as to follow the rise of the power-supply voltage VDD2. Then, at a time t12, the potential of the input voltage Vin1, Vin2, i.e., voltage supplied from the external terminal TVP1, TVP64 rises. At a time t13, the potential difference between the input voltage Vin1, Vin2 and the output voltage Vout1, Vout2 becomes a predetermined value, and therefore the switch circuit SW115 becomes an On-state. As a result, the output voltages Vout1 and Vout2 become voltages substantially equal to the voltages supplied from the external terminals TVP1 and TVP64 respectively. As a result, the potentials of the selection voltages VP1 to VP64, which are supplied from the ladder resistor unit 33 to the PchDAC 31, also rise so as to follow the rise of the power-supply voltage VDD2.

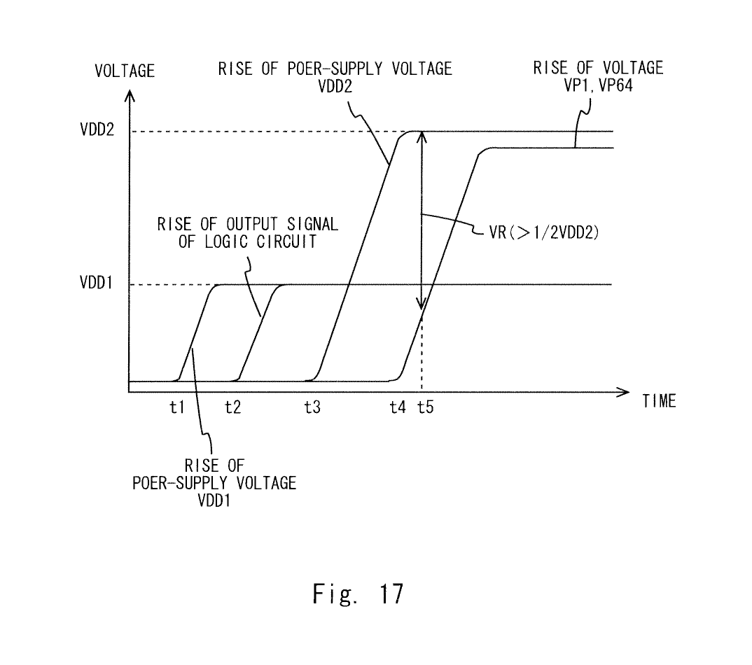

In the DAC circuit 30 in related art shown in FIG. 13, even when the power-supply voltage VDD2 has risen, the voltage VP1, VP64 from the external terminal has not risen sufficiently at this point. Therefore, as shown in FIG. 17, the potential difference VR from the power-supply voltage VDD2 could exceed the half of the power-supply voltage VDD2. In such a case, the potentials of the selection voltages VP1 to VP64, which are supplied from the ladder resistor unit 33 to the PchDAC 31, also exceed the half of the power-supply voltage VDD2. Therefore, there is a possibility that they exceed the withstand voltage between the back-gate and the source, between the back-gate and the drain, and between the back-gate and the gate of the PMOS transistor constituting each switch circuit of the PchDAC 31.

In contrast to this, in the DAC circuit 100 in accordance with this first exemplary embodiment of the present invention, even when the voltage VP1, VP64 from the external terminal has not risen sufficiently, the output voltage Vout1, Vout2 from the voltage supply control circuit 111, 112 rises so as to follow the rise of the power-supply voltage VDD2 as shown in FIGS. 3 and 5. As a result, the potentials of the selection voltages VP1 to VP64, which are supplied from the ladder resistor unit 33 to the PchDAC 31, also rise so as to follow the rise of the power-supply voltage VDD2. Therefore, it is possible to solve the problem that occurs in the DAC circuit 30 in the related art, i.e., the problem that the potential difference exceeds the withstand voltage between the back-gate and the source, between the back-gate and the drain, and between the back-gate and the gate of the PMOS transistor constituting each switch circuit of the PchDAC 31.

Further, since this problem is solved, there is no need to give consideration to the component-withstand margin of the PMOS transistor constituting each switch circuit of the PchDAC 31, thus making it possible to achieve the chip-shrinking corresponding to the withstand voltage equivalent to the half of the power-supply voltage VDD2. Furthermore, since the voltages supplied from the external terminals TVP1 and TVP64 can be turned on at an arbitrary timing, there is no need to add any additional control circuit that controls the power-up sequence in the power supply that generates the voltages VP1 and VP64 supplied through the external terminals, thus eliminating the demerit such as increase in the design costs and increase in the circuit size.

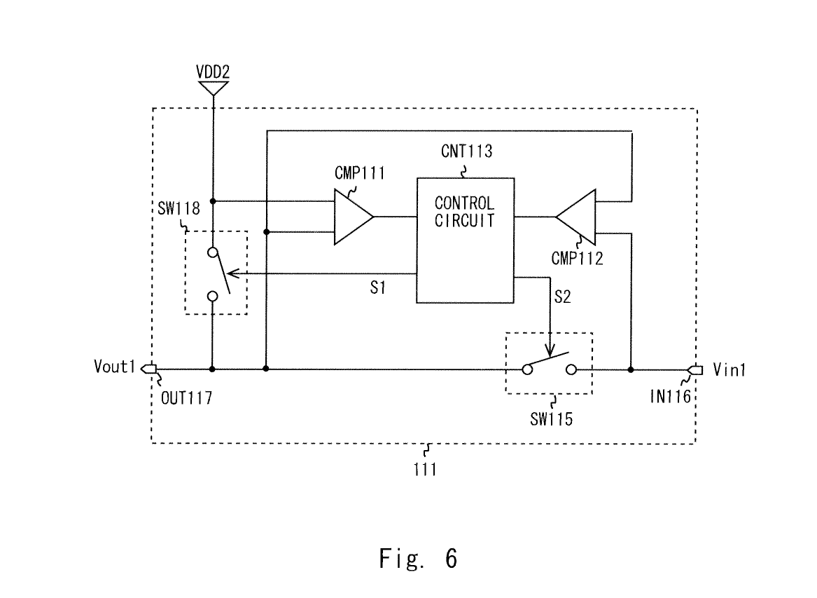

Further, the only requirement for the voltage supply control circuits 111 and 112 is to raise the output voltages Vout1 and Vout2 so as to follow the rise of the power-supply voltage VDD2. Therefore, a configuration shown in FIG. 6, for example, may be also employed. As shown in FIG. 6, the voltage supply control circuit 111 includes comparison detectors CMP111 and CMP112, a control circuit CNT113, switch circuits SW115 and SW118, an input terminal IN116, and an output terminal OUT117.

In the voltage supply control circuit 111 shown in FIG. 6, when the power-supply voltage VDD2 rises, the switch circuit SW118 becomes an On-state by a control signal S1 according to the detection result of the comparison detector CMP111 so that the potential difference between the power-supply voltage VDD2 and the output voltage Vout1 is kept from becoming wider. Further, based on the detection result of the comparison detector CMP112, when the potential difference between the input voltage Vin1, i.e., voltage supplied from the external terminal TVP1 and the output voltage Vout1 becomes a predetermined value, the switch circuit SW115 becomes an On-state by a switch control signal 52. Note that the switch circuit SW118 is turned off by the voltage control signal S1 at the moment when the switch circuit SW115 is turned on by the switch control signal 52. Note that the voltage supply control circuit 112 has a similar configuration to that of the voltage supply control circuit 111.

### Second Exemplary Embodiment

A second specific exemplary embodiment to which the present invention is applied is explained hereinafter in detail with reference to the drawings. Similarly to the first exemplary embodiment, the present invention is applied to a DAC circuit 100 of an LCD driver IC of a liquid-crystal display device in this second exemplary embodiment. The second exemplary embodiment is different from the first exemplary embodiment in the configuration of the voltage supply control circuits 111 and 112. Therefore, the second exemplary embodiment is explained with particular emphasis on that difference. The remaining common configuration was already explained with the first exemplary embodiment, and therefore its explanation is omitted.

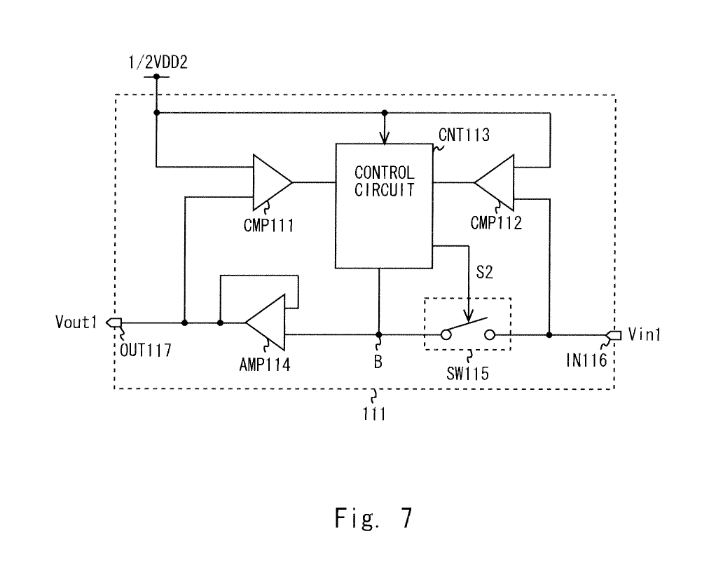

FIG. 7 shows a configuration of the voltage supply control circuit 111 in accordance with second exemplary embodiment. As shown in FIG. 7, the voltage supply control circuit 111 includes comparison detectors CMP111 and CMP112, a control circuit CNT113, an output amplifier AMP114, a switch circuit SW115, an input terminal IN116, and an output terminal OUT117. However, the second exemplary embodiment is different from the first exemplary embodiment in the following point.

The comparison detector CMP111 monitors a voltage equivalent to the half of the power-supply voltage VDD2 (hereinafter referred to as “reference voltage ½ VDD2”) and the output voltage Vout1, and detect a potential difference between them. Then, it outputs a detection result to the control circuit CNT 113. Note that the reference voltage ½ VDD2 may be generated by dividing the power-supply voltage VDD2 with two series-connected resistors. Further, the reference voltage is not limited to the voltage equivalent to the half of the power-supply voltage VDD2. That is, the reference voltage may be any voltage equal to or higher than ½ VDD2.

The comparison detector CMP112 monitors the input voltage Vin1 and the reference voltage ½ VDD2, and detects a potential difference between them. Then, it outputs a detection result to the control circuit CNT 113.

The control circuit CNT113 outputs a voltage control signal S1 to the node B according to the detection results of the comparison detectors CMP111 and CMP112, and also outputs a switch control signal S2 to the switch circuit SW115.

More specifically, the control circuit CNT113 outputs a voltage control signal S1 having a potential level substantially equal to the reference voltage ½ VDD2 to the node B according to the detection result of the comparison detector CMP111 so that the potential difference between the reference voltage ½ VDD2 and the output voltage Vout1 is kept from becoming wider. Then, when the input voltage Vin1 becomes equal to or higher than the reference voltage ½ VDD2 based on the comparison result of the comparison detector CMP112, the control circuit CNT113 raises the switch control signal S2 to a high level and thereby brings the switch circuit SW115 into an On-state. Note that an assumption is made here that the output of the voltage control signal S1 is stopped at the moment when the switch control signal S2 rises to a high level. The other configuration is similar to that of the first exemplary embodiment.

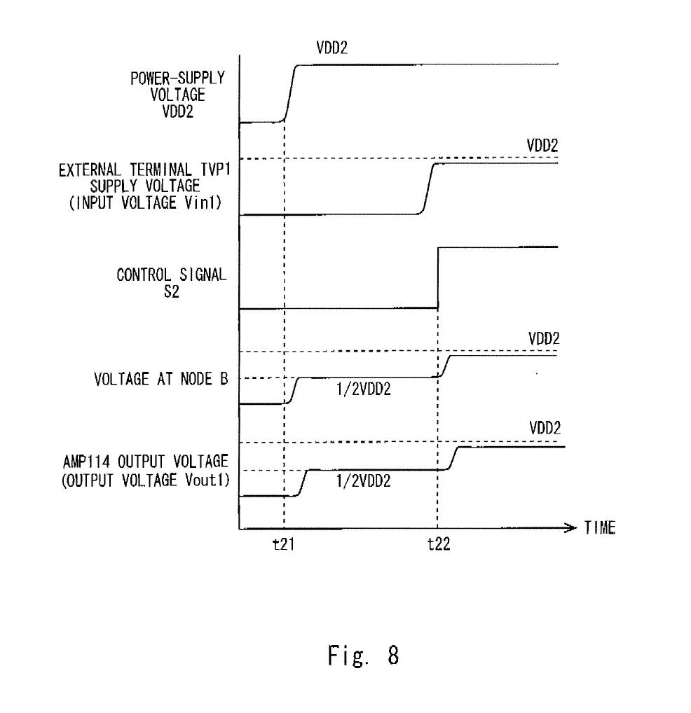

FIG. 8 shows a timing chart for explaining an operation of the voltage supply control circuit 111. As shown in FIG. 8, firstly, the power-supply voltage VDD2 is turned on at a time t21 and the potential of the power-supply voltage VDD2 gradually rises. Further, the reference voltage ½ VDD2, which is the half of the power-supply voltage VDD2, rises at the same time. At this point, the control circuit CNT113 raises the potential level of the voltage control signal S1 according to the detection result of the comparison detector CMP111 so that the potential difference between the reference voltage ½ VDD2 and the output voltage Vout1 is kept from becoming wider. As a result, the output amplifier AMP114 outputs a voltage substantially equal to the reference voltage ½ VDD2 as the output voltage Vout1.

Meanwhile, the comparison detector CMP112 detects that no voltage is supplied from the external terminal TVP1 or that the potential of the supplied voltage is low. The control circuit CNT113 maintains the switch control signal S2 at a low level based on this detection result, and the switch circuit SW115 electrically cuts off the node B from the input terminal IN116.

Next, at a time t22, the voltage supplied from the external terminal TVP1 is turned on and the potential of the input voltage Vin1 gradually rises. Further, at a time t13, the comparison detector CMP112 detects that the input voltage Vin1 becomes equal to or higher than the reference voltage ½ VDD2. The control circuit CNT113 raises the switch control signal S2 to a high level based on this detection result, and the switch circuit SW115 electrically connects the node B to the input terminal IN116. As a result, the potential of the input voltage Vin1, i.e., voltage supplied from the external terminal TVP1 is input to the output amplifier AMP114. Therefore, the output amplifier AMP114 outputs a voltage substantially equal to the voltage supplied from the external terminal TVP1 as the output voltage Vout1.

Note that the configuration of the voltage supply control circuit 112 is similar to that of the voltage supply control circuit 111. However, a voltage supplied from the external terminal TVP64 is input to the input terminal IN116 of the voltage supply control circuit 112.

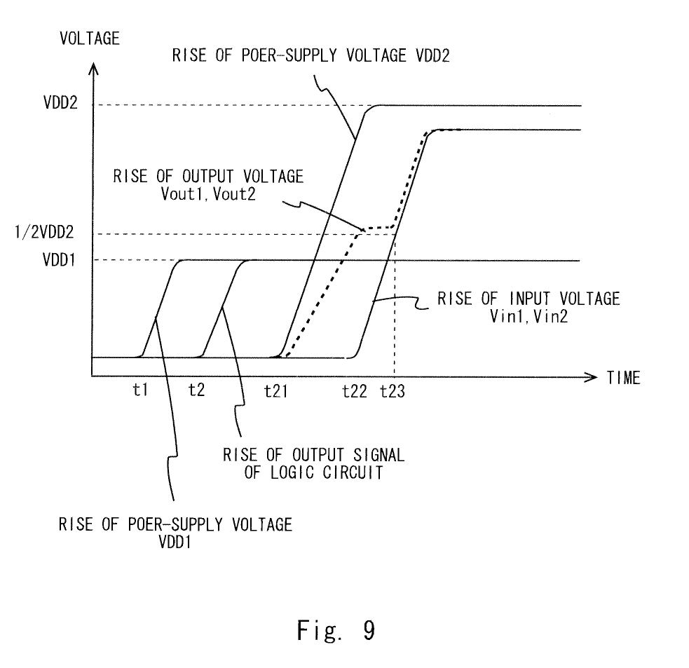

FIG. 9 is a schematic diagram showing a sequence of an LCD driver IC in accordance with this second exemplary embodiment performed upon power-up. As shown in FIG. 9, firstly, the power-supply voltage VDD1 around 4V that is used by the logic circuit 10 rises at a time t1. Then, at a time t2, the logic circuit 10 starts to operate and thereby outputs an output signal SGNL. Next, at a time t21, the power-supply voltage VDD2 for high-voltage driver power supply rises. At this point, as explained above with reference to FIG. 8, the output voltage Vout1, Vout2 from the voltage supply control circuit 111, 112 follows the rise of the power-supply voltage VDD2 and the half voltage of the power-supply voltage VDD2 is output.

Then, at a time t22, the potential of the input voltage Vin1, Vin2, i.e., voltage supplied from the external terminal TVP1, TVP64 rises. At a time t23, the potential of the input voltage Vin1, Vin2 becomes equal to or higher than the half voltage of the power-supply voltage VDD2, and therefore the switch circuit SW115 becomes an On-state. As a result, the output voltages Vout1 and Vout2 become voltages substantially equal to the voltages supplied from the external terminals TVP1 and TVP64 respectively. As a result, the potentials of the selection voltages VP1 to VP64, which are supplied from the ladder resistor unit 33 to the PchDAC 31, also rise so as to follow the rise of the power-supply voltage VDD2.

As has been described above, in the DAC circuit 100 in accordance with the second exemplary embodiment of the present invention, since the voltage supply control circuits 111 and 112 have the configuration like the one shown in FIG. 8, the half voltage of the power-supply voltage VDD2 is output so as to follow the rise of the power-supply voltage VDD2 during the period in which the voltage VP1, VP64 from the external terminal has not risen sufficiently. Then, when voltage VP1, VP64 from the external terminal becomes equal to or higher than the half voltage of the power-supply voltage VDD2, a potential substantially equal to the voltage VP1, VP64 is output.

As a result, similarly to the first exemplary embodiment, even when the voltage VP1, VP64 from the external terminal has not risen sufficiently, it is possible to prevent the potential difference from exceeding the withstand voltage between the back-gate and the source, between the back-gate and the drain, and between the back-gate and the gate of the PMOS transistor constituting each switch circuit of the PchDAC 31.

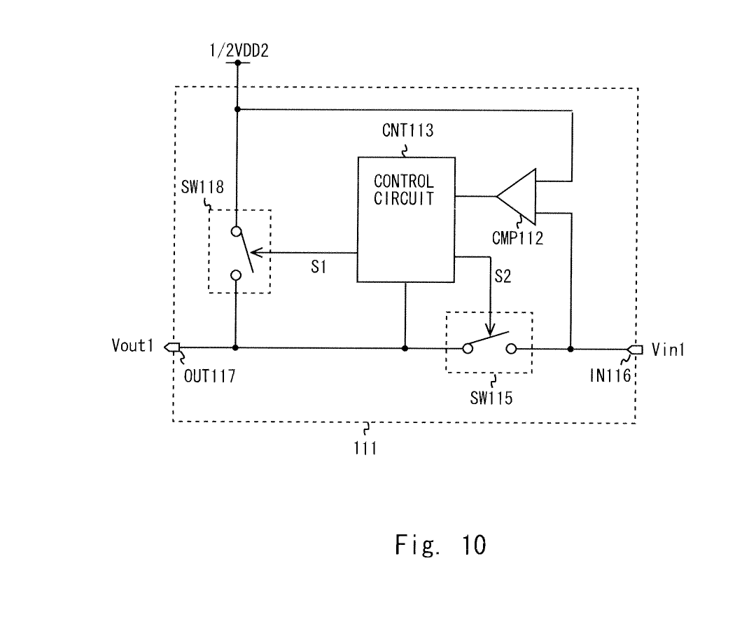

Further, the only requirement for the voltage supply control circuits 111 and 112 is to adjust the output voltages Vout1 and Vout2 to the half voltage of the power-supply voltage VDD2 so as to follow the rise of the power-supply voltage VDD2. Therefore, a configuration shown in FIG. 10, for example, may be also employed. As shown in FIG. 10, the voltage supply control circuit 111 includes a comparison detector CMP112, a control circuit CNT113, switch circuits SW115 and SW118, an input terminal 1N116, and an output terminal OUT117.

In the voltage supply control circuit 111 shown in FIG. 10, when the power-supply voltage VDD2 rises and hence the reference voltage ½ VDD2 rises, the comparison detector CMP112 monitoring the output voltage Vout1 performs a comparison to determine whether the output voltage Vout1 is equal to or higher than the reference voltage ½ VDD2 or not and outputs the determination result to the control circuit CNT113. When the output voltage Vout1 is equal to or lower than the reference voltage ½ VDD2, the control circuit CNT113 brings the switch circuit SW118 into an On-state and brings the switch circuit SW115 into an Off-state. Then, based on the detection result of the comparison detector CMP112, when the input voltage Vin1, i.e., voltage supplied from the external terminal TVP1 becomes equal to or higher than the reference voltage ½ VDD2, the control circuit CNT113 brings the switch circuit SW118 into an Off-state and brings the switch circuit SW115 into an On-state.

Even with the configuration like this, the voltage supply control circuit 111 outputs the half voltage of the power-supply voltage VDD2 so as to follow the rise of the power-supply voltage VDD2 during the period in which the voltage VP1, VP64 from the external terminal has not risen sufficiently. Then, when the voltage VP1, VP64 from the external terminal becomes equal to or higher than the half voltage of the power-supply voltage VDD2, the voltage supply control circuit 111 outputs a potential substantially equal to the voltage VP1, VP64.

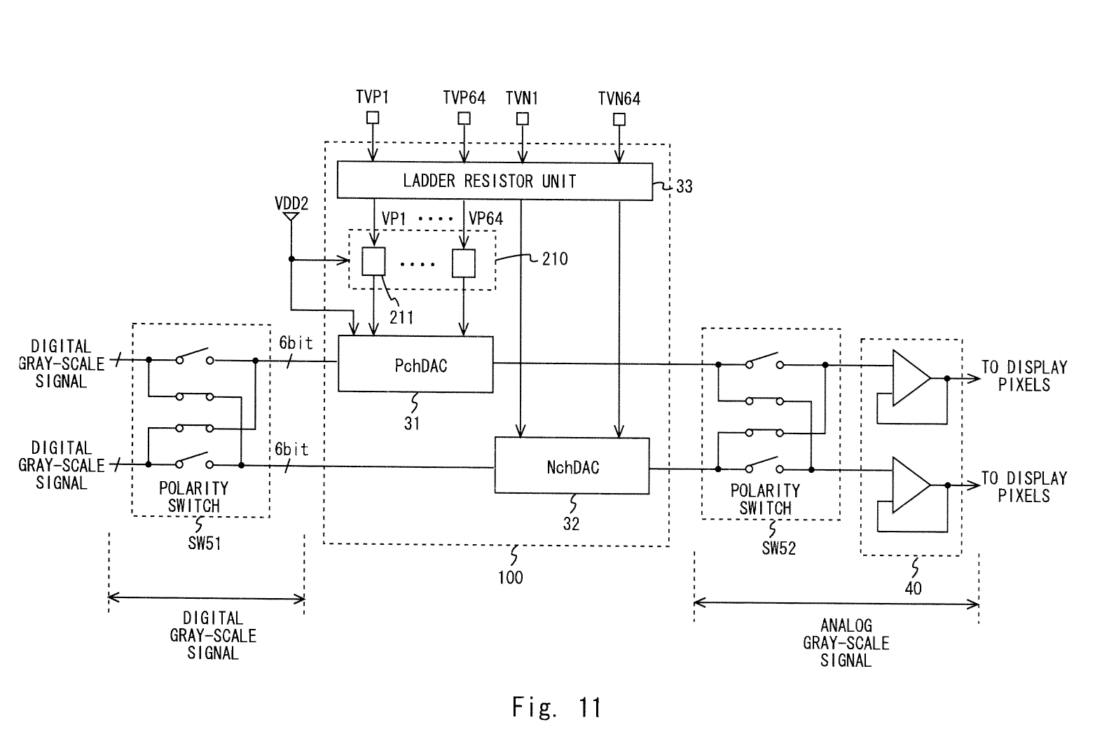

Note that the present invention is not limited to the above-described exemplary embodiments, and various modifications can be made without departing from the spirit and scope of the present invention. For example, a voltage supply control unit 210 may be connected between the ladder resistor unit 33 and the PchDAC 31 as shown in FIG. 11. The voltage supply control unit 210 includes the same number of voltage supply control circuits as the number of voltages VP1 to VP64 supplied by the PchDAC 31, and each of the voltage supply control circuits has a similar configuration as that of the voltage supply control circuit 111. Even with the configuration like this, it is possible to solve the problem that the potential difference exceeds the withstand voltage between the back-gate and the source, between the back-gate and the drain, and between the back-gate and the gate of the PMOS transistor constituting each switch circuit of the PchDAC 31, though the circuit size may increase.

Further, although the selection voltages are generated by dividing voltages supplied from the two external terminals TVP1 and TVP64 with the ladder resistor unit 33 in the first and second exemplary embodiments, the number of the external terminals is not limited to two. That is, the selection voltages may be generated by using voltages supplied from three or more external terminals.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

The first and second exemplary embodiments can be combined as desirable by one of ordinary skill in the art.

What is claimed is:

1. A D/A converter circuit for a drive circuit provided in a display device, comprising:
a D/A converter unit that selects one of a plurality of selection voltages according to an input digital gray-scale signal, and outputs the selected selection voltage as an analog gray-scale signal;
a first power-supply voltage terminal through which a first power-supply voltage is supplied to a first terminal of a transistor constituting the D/A converter unit upon power-up of the D/A converter unit; and
a voltage supply control unit that detects a potential difference between the first power-supply voltage and a second voltage used to generate the selection voltages, outputs a voltage corresponding to the first power-supply voltage to a second terminal of the transistor constituting the D/A converter unit when the potential difference is larger than a predetermined value, and outputs a voltage corresponding to the second voltage to the second terminal of the transistor constituting the D/A converter unit when the potential difference is smaller than the predetermined value.

2. The D/A converter according to claim 1, wherein
the voltage supply control unit comprises a switch circuit,
when the potential difference is larger than the predetermined value, the voltage supply control unit brings the switch circuit into a cut-off state and outputs a voltage corresponding to the first power-supply voltage, and
when the potential difference is smaller than the predetermined value, the voltage supply control unit brings the switch circuit into a conductive state and outputs a voltage corresponding to the second voltage.

3. The D/A converter according to claim 2, wherein
the voltage supply control unit comprises a control circuit and an amplifier that outputs a voltage according to an input voltage,
the switch circuit is connected between an input of the amplifier and a terminal through which the second voltage is supplied, and
the control circuit brings the switch circuit into a cut-off state when the potential difference is larger than the predetermined value, and brings the switch circuit into a conductive state when the potential difference is smaller than the predetermined value.

4. The D/A converter according to claim 1, further comprising a ladder resistor unit that generates the plurality of selection voltages corresponding to the second voltage.

5. The D/A converter according to claim 1, wherein the predetermined value is a value smaller than a half of the first power-supply voltage.

6. The D/A converter according to claim 1, wherein the transistor constituting the D/A converter unit is a PMOS transistor.

7. The D/A converter according to claim 6, wherein the first terminal of the transistor is a back-gate voltage supply terminal.

8. The D/A converter according to claim 6, wherein the second terminal of the transistor is either a drain terminal or a source terminal.

9. The D/A converter according to claim 1, wherein the second voltage is supplied from an external terminal of the D/A converter circuit.

10. The D/A converter according to claim 1, wherein the display device is a liquid-crystal display device, and the drive circuit is a source driver for dot inversion drive.

11. A voltage supply control method for a D/A converter circuit of a drive circuit provided in a display device,
supplying a voltage corresponding to a first power-supply voltage to a first terminal of a transistor constituting a D/A converter unit when the D/A converter unit is powered on, the D/A converter unit being configured to select one of a plurality of selection voltages according to an input digital gray-scale signal and output the selected selection voltage as an analog gray-scale signal; and
when a potential difference between the first power-supply voltage and a second voltage used to generate the selection voltages is larger than a predetermined value, the first power-supply voltage is output to a second terminal of the transistor constituting the D/A converter unit, whereas when the potential difference is smaller than the predetermined value, a voltage corresponding to the second voltage is output to a second terminal of the transistor constituting the D/A converter unit.

12. The voltage supply control method for a D/A converter circuit according to claim 11, wherein the predetermined value is a value smaller than a half of the first power-supply voltage.

13. The voltage supply control method for a D/A converter circuit according to claim 11, wherein
the transistor is a PMOS transistor and the first terminal is a back-gate voltage supply terminal, and
the second terminal of the transistor is either a drain terminal or a source terminal.
